(19) United States
(12) Patent Application Publication
(10) Pub. No.: US 2025/0166273 A1
(43) Pub. Date: May 22, 2025

(54) RELIGHTABLE AND REANIMATABLE NEURAL HEADS

(71) Applicants: DISNEY ENTERPRISES, INC., Burbank, CA (US); ETH Zürich (Eidgenössische Technische Hochschule Zürich), Zürich (CH)

(72) Inventors: Derek Edward BRADLEY, Zürich (CH); Prashanth CHANDRAN, Zürich (CH); Sebastian Klaus WEISS, Zürich (CH); Yingyan XU, Zürich (CH); Gaspard ZOSS, Zürich (CH)

(21) Appl. No.: 18/951,325

(22) Filed: Nov. 18, 2024

Related U.S. Application Data
(60) Provisional application No. 63/600,333, filed on Nov. 17, 2023.

(51) Int. Cl. G06T 13/40; G06T 15/20; G06T 15/50; G06T 17/20

(52) U.S. Cl. CPC G06T 13/40; G06T 15/20; G06T 15/506; G06T 17/20

(57) ABSTRACT

The present invention sets forth techniques for generating an animation sequence. The techniques include receiving one or more three-dimensional (3D) input meshes, wherein each input mesh includes a representation of an object included in a 3D scene. The techniques also include receiving, for each of the 3D input meshes, a virtual camera position associated with the 3D input mesh and one or more virtual lighting positions associated with the 3D input mesh. The techniques further include generating, for each of the 3D input meshes and via a trained machine learning model, one or more rendered frames associated with the 3D input mesh, wherein each rendered frame includes a two-dimensional (2D) representation of the object as viewed from the virtual camera position and illuminated by one or more virtual lights located at the one or more virtual lighting positions, and generating an output animation sequence based on the rendered frames.

### CROSS-REFERENCE TO RELATED APPLICATIONS

This application claims priority benefit to U.S. provisional application titled “RELIGHTABLE AND ANIMATABLE NEURAL HEADS,” filed on Nov. 17, 2023, and having Ser. No. 63/600,333. This related application is also hereby incorporated by reference in its entirety.

### BACKGROUND

### Field of the Various Embodiments

Embodiments of the present disclosure relate generally to machine learning and computer vision and, more specifically, to techniques for creating animatable and relightable representations of one or more three-dimensional (3D) objects included in a scene from one or more two-dimensional (2D) representations of the scene.

### Description of the Related Art

Generating a 3D representation of a scene including one or more 3D objects is a common task in the fields of computer vision and computer graphics. This representation of the scene may be generated from one or more 2D representations of the scene. In some applications, different representations of a scene are generated from different viewpoints, where a viewpoint is a combination of a specific camera location and a specific orientation of the camera relative to the scene. For instance, multiple 2D representations of a scene may be captured by placing one or more cameras at specific locations and with specific orientations relative to the scene. The captured 2D representations may then be used to generate additional 2D representations of the scene from different camera viewpoints. Further, generating different 2D representations of a scene also allows creators to modify the scene. For example, objects (either real or computer-generated) may be added to the scene, objects may be removed from the scene, or the relative positions of objects in the scene may be altered.

Existing techniques for generating 3D representations of scenes may employ neural radiance fields. A neural radiance field (NeRF) is a machine learning model that is trained on a training data set including multiple 2D representations of a scene captured from various camera viewpoints and orientations. The output of a trained NeRF is a radiance field function that produces a color value and a volume density for any given combination of a 3D location within the scene and a viewing angle to the 3D location from a specified viewpoint within the scene. The trained NeRF may be used to generate 2D representations of the scene for arbitrary camera viewpoints.

One drawback of some existing NeRF implementations is that the output of the trained NeRF may be dependent upon the scene illumination at the time that the multiple 2D representations of the scene in the training data set were captured. During training, the NeRF learns the characteristics of the scene illumination in addition to learning the characteristics of the objects depicted in the scene. The output of the trained NeRF for a given 3D location in the scene from a given viewpoint includes the light emitted from the 3D location toward the viewpoint as determined by the scene illumination present in the multiple 2D representations of the scene. Consequently, the output of a NeRF that has been trained on 2D representations of a scene captured under specific illumination conditions (e.g., in a photo or movie studio) may not be rendered realistically within another environment that has different illumination conditions. While some existing NeRF implementations may be operable to generate novel 2D views of a 3D scene under both arbitrary camera viewpoints and arbitrary lighting conditions, these implementations may still only generate static 2D representations of a static 3D scene, and may not be suitable for generating animated performances based on multiple 2D representations of a scene including dynamically moving content.

Other existing techniques for generating 3D representations of scenes may include other 3D representations, such as a Mixture of Volumetric Primitives (MVP) representation. An MVP representation may include a collection of animatable, minimally overlapping volumetric primitives, such as cubes, that collectively parameterize the color and opacity distribution in a 3D space over time. While existing MVP representations may allow for efficient rendering of animated performances based on a multiple 2D representations of a scene, these representations, similar to some existing NeRF representations, encode the scene illumination present in the multiple 2D representations of the scene. Consequently, the output of an MVP representation that has been trained on 2D representations of a scene captured under specific illumination conditions may not be rendered realistically within another environment that has different illumination conditions.

As the foregoing illustrates, what is needed in the art are more effective techniques generating 3D representations of scenes having different illumination conditions.

### SUMMARY

One embodiment of the present invention sets forth a technique for generating an animation sequence. The technique includes receiving one or more three-dimensional (3D) input meshes, wherein each input mesh includes a representation of an object included in a 3D scene and receiving, for each of the one or more 3D input meshes, a virtual camera position associated with the 3D input mesh and one or more virtual lighting positions associated with the 3D input mesh. The technique also includes generating, for each of the one or more 3D input meshes and via a trained machine learning model, one or more rendered frames associated with the 3D input mesh, wherein each of the one or more rendered frames includes a two-dimensional (2D) representation of the object as viewed from the virtual camera position and illuminated by one or more virtual lights located at the one or more virtual lighting positions. The technique further includes generating an output animation sequence based on the one or more rendered frames.

One technical advantage of the disclosed techniques relative to the prior art is that the disclosed techniques may generate animatable representations of a 3D scene not only from arbitrary viewpoints, but also under arbitrary lighting conditions. Unlike existing techniques that are limited to producing animatable representations with fixed illumination characteristics, the disclosed techniques allow for realistically rendering animated representations of a 3D scene into a variety of environments with different camera positions and illumination conditions, including both nearfield lighting and nearfield camera positions. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of the training engine of FIG. 1, according to some embodiments.

FIG. 3 is a flow diagram of method steps for training a relightable Mixture of Volumetric Primitives (MVP) model, according to some embodiments.

FIG. 4 is a more detailed illustration of the inference engine of FIG. 1, according to some embodiments.

FIG. 5 is a flow diagram of method steps for generating an output animation sequence, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

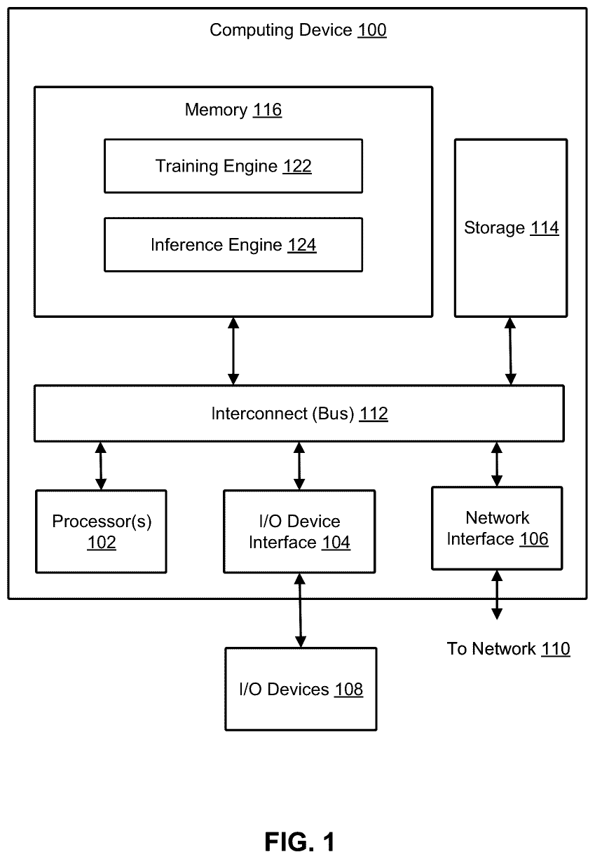

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an inference engine 124 that reside in a memory 116.

It is noted that the computing device described herein is illustrative and that any other technically feasible configurations fall within the scope of the present disclosure. For example, multiple instances of training engine 122 or inference engine 124 could execute on a set of nodes in a distributed and/or cloud computing system to implement the functionality of computing device 100. In another example, training engine 122 or inference engine 124 could execute on various sets of hardware, types of devices, or environments to adapt training engine 122 or inference engine 124 to different use cases or applications. In a third example, training engine 122 or inference engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. One or more of training engine 122 or inference engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 or inference engine 124.

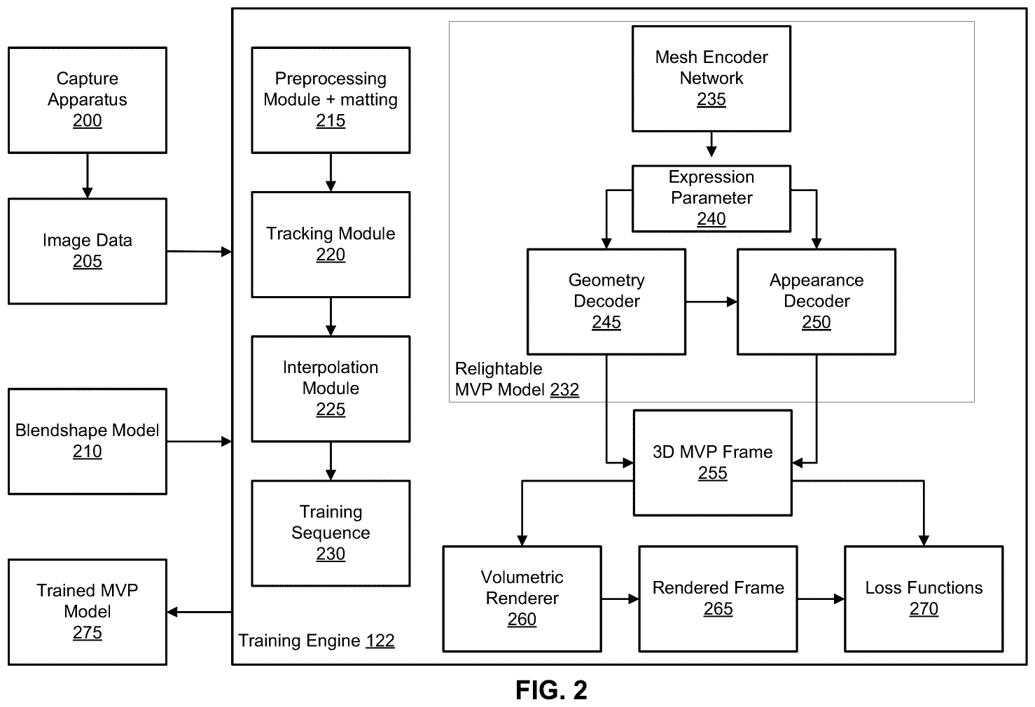

FIG. 2 is a more detailed illustration of training engine 122 of FIG. 1, according to some embodiments. Training engine 122 generates a relightable trained Mixture of Volumetric Primitives (MVP) model 275 based on image data 205 recorded via capture apparatus 200 and a blendshape model 210. Training engine 122 includes, without limitation, preprocessing module 215, tracking module 220, interpolation module 225, training sequence 230, 3D MVP frame 255, volumetric renderer 260, rendered frame 265, and loss functions 270. Training engine 122 also includes relightable MVP model 232 comprising at least mesh encoder network 235, expression parameter 240, geometry decoder 245, and appearance decoder 250.

Capture apparatus 200 includes an arrangement of multiple cameras and multiple light sources, operable to capture multiple 2D representations of a 3D scene including one or more objects. In various embodiments, the 3D scene may include a human actor positioned such that each of the multiple light sources is operable to illuminate the actor's head and each of the multiple cameras is operable to capture an image of the actor's head. For example, the 3D scene may be illuminated by one or more of thirty-two light sources positioned in different locations within a frontal hemisphere of a capture volume, and the 3D scene may be captured by one or more of ten cameras positioned in different locations within the frontal hemisphere of the capture volume, where the positions of the multiple cameras and multiple light sources are calibrated within a 3D coordinate system. Capture apparatus 200 may illuminate the 3D scene via a one-light-at-a-time (OLAT) technique, where only one of the multiple light sources is illuminated while capturing the 3D scene. Capture apparatus 200 may also illuminate the 3D scene via a full-on technique, where all of the multiple light sources are illuminated while capturing the 3D scene.

In various embodiments, capture apparatus 200 may capture a dynamic performance of a human actor included in the 3D scene while flashing a dedicated lighting sequence consisting of one illuminated light source per frame (OLAT frames). Capture apparatus 200 may also intermix a full-on frame illuminated by all of the multiple light sources once every predetermined number of frames, e.g., every three frames. Capture apparatus 200 captures the full-on frames to improve the subsequent tracking of a 3D mesh representation of the actor's head as described below.

In an embodiment including 32 light sources, capture apparatus 200 may therefore capture a sequence of frames include OLAT frames O₁, O₂, O₃, O₄, . . . , O₃₁, O₃₂ and full-on frames F in the predetermined lighting sequence F, O₁, O₂, F, O₃, O₄, F, . . . , F, O₃₁, O₃₂. Each of the OLAT frames O₁, O₂, O₃, O₄, . . . , O₃₁, O₃₂ represents a frame captured while the 3D scene is illuminated by a different one of the multiple, e.g., thirty-two light sources, while each of the full-on frames F represents a frame captured while the 3D scene is illuminated by all of the light sources. Capture apparatus 200 captures the dynamic performance at a predetermined frame rate, e.g., twenty-four frames per second, while repeating the above predetermined lighting sequence throughout the duration of the captured dynamic performance.

In various embodiments, the above predetermined lighting sequence F, O₁, O₂, F, O₃, O₄, F, . . . , F, O₃₁, O₃₂ maximizes visual differences between adjacent captured OLAT frames, such as OLAT frames O₁ and O₂. Visual differences between multiple captured frames allow training engine 122 to train the MVP model more efficiently. An actor's expression may not change significantly between adjacent captured frames, but the predetermined lighting sequence may be chosen as to maximally vary the illumination on the actor's head from one OLAT frame to the next OLAT frame. For example, OLAT frames O₁ and O₂ may illuminate the actor's head from above and below, respectively. Likewise, OLAT frames O₃ and O₄ may illuminate the actor's head from the left and right sides, respectively. Capture apparatus 200 generates image data 205 based on the sequence of captured OLAT and full-on frames.

Image data 205 includes a sequence of frames captured as described above. Each frame includes multiple images of the actor's head captured at a particular instant via the multiple, e.g., ten, cameras. As described above, some of the frames included in the sequence of frames represent OLAT frames illuminated by an individual light source, while other frames included in the sequence of frames represent full-on frames illuminated by all of the multiple light sources.

Blendshape model 210 includes one or more parameters describing the shape of the specific actor's head captured by capture apparatus 200. In various embodiments, the disclosed techniques include pre-computing blendshape model 210 based on a set of 3D face scans of the specific actor. As discussed below in the descriptions of tracking module 220 and interpolation module 225, training engine 122 generates a tracked 3D mesh representing the shape of actor's head by modifying the one or more parameters included in blendshape model 210 based on the actor's changing facial expressions included in the frames captured by capture apparatus 200 and included in image data 205.

Preprocessing module 215 analyzes received image data 205. For each image associated with a frame included in image data 205, preprocessing module 215 records the position of the camera used to capture the image. For each image associated with an OLAT frame included in image data 205, preprocessing module 215 also records the position of the single light source used to illuminate the OLAT frame.

Preprocessing module 215 also generates a mask for each image associated with an OLAT frame included in image data 205. For each image, the generated mask defines a region of pixels included in the image representing the actor's head, and distinguishes the actor's head from a background included in the captured 3D scene. As discussed below in the description of loss functions 270, training engine 122 evaluates an output of the MVP model based at least on a comparison of the output to the generated masks.

Tracking module 220 generates a 3D mesh based on blendshape model 210 and associated with an image included in image data 205. In various embodiments, tracking module 220 generates a 3D mesh associated with each of the images included in a frame captured by capture apparatus 200 under full-on lighting, rather than under OLAT lighting. Tracking module 220 modifies the parameters included in blendshape model 210 via any suitable 3D face tracking technique that is operable to match 2D landmarks detected within multiple, e.g., ten, images included in a frame captured under full-on lighting. In various embodiments, the parameters included in blendshape model 210 encode both a facial expression and a head pose associated with the actor. Tracking module 220 generates the 3D mesh associated with an image based only on the facial expression depicted in the image. Tracking module 220 analyzes the relatively small per-frame variations in the actor's head pose, and inversely offsets the per-frame camera position based on the head pose variations. Offsetting the per-frame camera position based on the head pose variations effectively places the images in a consistent, stabilized 3D space.

Interpolation module 225 generates a 3D mesh for each image included in a frame captured by capture apparatus 200 under OLAT lighting conditions. The OLAT illumination may not be sufficient for a 3D face tracking technique to detect and match 2D landmarks included in multiple images included in an OLAT frame. Interpolation module 225 instead estimates parameters included in blendshape model 210 and associated with each OLAT image via any suitable interpolation technique executed on the full-on frames adjacent to the OLAT frames. For example, given the predetermined lighting sequence F, O₁, O₂, F, O₃, O₄, F, . . . , F, O₃₁, O₃₂ discussed above, interpolation module 225 may estimate blendshape model 210 parameters for OLAT frames O₁ and O₂ via interpolation between blendshape model 210 parameters included in the full-on frames F captured before and after OLAT frames O₁ and O₂. Interpolation module 225 generates a 3D mesh associated with each OLAT image based on the interpolated blendshape model 210 parameters. Training engine 122 processes image data 205, the masks generated by preprocessing module 215, and the 3D masks generated by tracking module 220 and interpolation module 225 to generate training sequence 230.

Training sequence 230 includes multiple frames, where each frame includes multi-view images captured by, e.g., ten calibrated camera positions, one 3D light source position corresponding to the location of the OLAT light source used to illuminate the multi-view images, and a tracked 3D mesh representing a facial expression depicted in the multi-view images. In various embodiments, training engine 122 may discard frames included in image data 205 that are illuminated under full-on lighting conditions, along with 3D meshes associated with images included in the full-on frames.

Training engine 122 may train relightable Mixture of Volumetric Primitives (MVP) model 232 based on training sequence 230. In various embodiments, trainable components of relightable MVP model 232 include, without limitation, mesh encoder network 235, geometry decoder 245, and appearance decoder 250, all of which are discussed in further detail below.

Relightable MVP model 232 receives a 3D mesh representing an actor's head and associates a number of partially overlapping volumetric primitives, such as cubes, to the 3D mesh. The sizes of each of the volumetrics primitives may vary, but are each relatively small compared to the object represented by the 3D mesh. Relightable MVP model 232 generates expression parameter 240 described below based on a facial expression depicted in the 3D mesh. Geometry decoder 245 may translate, rotate, and/or scale each of the volumetric primitives based on expression parameter 240. Appearance decoder 250 may adjust the color and opacity of each of the volumetric primitives based on expression parameter 240 and calculated local lighting and view directions from the light source and camera used to capture an image to each of the volumetric primitives. Relightable MVP model 232 generates 3D MVP frame 255 including multiple processed volumetric primitives that collectively represent the captured actor having the expression depicted in the 3D mesh and under the illumination conditions determined by the position of the light source.

Mesh encoder network 235 generates expression parameter 240 (z) based on the 3D mesh associated with a frame included in training sequence 230. In various embodiments, mesh encoder network 235 may include a Deep Appearance Model as is known in the art, modified to generate expression parameter 240 based on the 3D mesh alone. Expression parameter 240 may be expressed as a 256-dimensional vector. Relightable MVP model 232 may also include a trainable single-layer MLP (not shown) that maps the 256-dimensional expression parameter 240 to a 16,384-dimensional vector that is then reshaped to an 8×8 feature map including 256 channels. Training engine 122 transmits the mapped and reshaped feature map to each of geometry decoder 245 and appearance decoder 250.

Geometry decoder 245 includes a machine learning model, e.g., a fully-connected neural network, that modifies, via various learned world-space transformations, the position, orientation, and size of each of a set of 3D primitives { [symbol] ₖ} that are associated with a 3D mesh encoded via expression parameter 240 (z) and cover the occupied regions of the 3D scene represented by the 3D mesh. Each 3D primitive includes volumetric red, green, blue, and opacity (RGBα) information that may be used in traditional volumetric rendering techniques. The 3D primitives are arranged in a 2D grid of size N×N, where N=16 or N=64 in various embodiments, and associated with positions on a 3D guide mesh via a UV parameterization technique. Geometry decoder 245 may predict the 3D guide mesh as an initialization of the various world-space transformations, prior to refining the various world-space transformations. Each of the N² primitives [symbol] ₖ is defined by:

$${𝒱}_{k} = ( {t}_{k} , {R}_{k} , {s}_{k} , {C}_{k} ) \qquad Equation ( 1 )$$

where the learned world-space transformations include a translation tₖ∈ [symbol] , a rotation Rₖ∈SO(3), and a non-uniform scale sₖ∈ [symbol] .

Geometry decoder 245 receives expression parameter 240 (z) and estimates transformations including translation tₖ∈ [symbol] , rotation Rₖ∈SO(3), and non-uniform scale sₖ∈ [symbol] for each of the N² primitives [symbol] ₖ based on expression parameter 240 (z). The estimated transformations collectively described the estimated geometry of the N² primitives [symbol] ₖ.

Geometry decoder 245 also calculates local view and lighting directions associated with each primitive [symbol] ₖ. Based on a light source position and a camera position associated with a frame included in training sequence 230, geometry decoder 245 calculates a local view direction vₖ associated with each primitive [symbol] ₖ, where the local view direction specifies a direction from the camera position p_{cam} to the primitive [symbol] _{K}:

$${v}_{k} = {p}_{cam} - {R}_{k} \cdot {t}_{k} \qquad Equation ( 2 )$$

Geometry decoder 245 also calculates a local lighting direction Iₖ associated with each primitive [symbol] ₖ, where the local lighting direction specifies a direction from the OLAT light source position pₒₗₐₜ to the primitive [symbol] :

$${l}_{k} = {P}_{olat} - {R}_{k} \cdot {t}_{k} \qquad Equation ( 3 )$$

Geometry decoder 245 transmits the calculated local view and local lighting directions vₖ and Iₖ to appearance decoder 250.

Appearance decoder 250 includes a machine learning model, e.g., a convolutional neural network, that estimates the appearance of each of the N² primitives [symbol] ₖ based on expression parameter 240 (z) and the local view and lighting directions received from geometry decoder 245. The appearance of each primitive [symbol] ₖ is defined by a dense M×M×M voxel grid of color information Cₖ∈ [symbol] , which stores the RGBα value per voxel. In various embodiments, Mₓ=M_{y}=M_{z}=M=16. In an example where N=64 and Mₓ=M_{y}=M_{z}=M=16, the set of primitives { [symbol] } is expressed as a 64×64 grid of primitives, where each primitive [symbol] includes a three-dimensional voxel grid including 16×16×16=4096 voxels, each voxel including associated color and alpha (opacity) values.

Appearance decoder 250 receives the reshaped expression parameter 240 (z) as input, and estimates the color and opacity (RGBα) values Cₖ associated with each primitive [symbol] ₖ included in the set of 3D primitives { [symbol] }. Appearance decoder 250 estimates the RGBα values Cₖ associated with each primitive [symbol] in UV space based on expression parameter 240 (z) and the local view and lighting directions received from geometry decoder 245.

Appearance decoder 250 combines and stores the local view and light directions per primitive as a single 6-channel image in UV space at a full network output resolution, e.g., 1024×1024. Appearance decoder 250 copies the view and light vectors to every voxel within an individual primitive. The concatenated set of {vₖ} and {Iₖ} is denoted as I∈ [symbol] . In various embodiments, appearance decoder 250 includes seven transpose convolution layers with a kernel size of 4, stride 2 and padding 1 that increase the feature map resolution from 8×8 by a factor of two at every step until the final resolution of 1024×1024 is reached. The inputs to the convolutional layers are the previous feature maps, starting with the 8×8 map representing reshaped expression parameter 240 (z) and the six channels from I bilinearly downsampled to match the current spatial resolution. The output features generated by the seven transpose convolution layers include channels having dimensionalities of 256,128,128,64,64,32, and 48, respectively, where the final 48 channels are interpreted as rgb×M_{z}.

At each convolutional level included in appearance decoder 250, I is bilinearly downsampled and concatenated to the intermediate feature layers before proceeding to the next layer. This downsampling operation has the effect of averaging local view and light directions across neighboring primitives, which is acceptable since neighboring primitives are located close to each other in 3D space. At early layers, the averaged view and light directions resemble global view and light vectors, while at deeper layers the per-primitive view and light directions may specialize the appearance Cₖ of each primitive individually. The local view and light conditioning allows the disclosed techniques to model nearfield lighting and viewpoints, as well as global lighting and viewpoints. The local view and light conditioning is only applied to the RGB component of the output Cₖ, as opacity α is independent of illumination and view direction. Training engine 122 combines the estimated primitive geometry received from geometry decoder 245 with the estimated primitive appearances received from appearance decoder 250 to generate 3D MVP frame 255.

3D MVP frame 255 includes the set of 3D primitives { [symbol] ₖ} each having geometry, e.g., position, orientation, and size, estimated by geometry decoder 245 and appearance Cₖ estimated by appearance decoder 250. Training engine 122 transmits 3D MVP frame 255 to volumetric renderer 260 and loss functions 270.

Volumetric renderer 260 receives 3D MVP frame 255 and generates rendered frame 265 via any suitable volumetric rendering technique, such as a differentiable raytracer. Based on the camera position associated with 3D MVP frame 255 and the volumetric data included in 3D MVP frame 255, including the geometry information and appearance information associated with the set of 3D primitives { [symbol] ₖ}, volumetric renderer 260 generates rendered frame 265 representing the actor as depicted in a corresponding frame included in training sequence 230 and processed by relightable MVP model 232. Rendered frame 265 includes an associated final resolution, e.g., 1024×1024 pixels, where each pixel includes RGBα color and opacity information. Training engine 122 transmits rendered frame 265 to loss functions 270.

Loss functions 270 evaluate the fidelity of rendered frame 265 to a corresponding frame included in training sequence 230 and processed by relightable MVP model 232 as described above. Loss functions 270 include a matting loss that compares the mask [symbol] generated by preprocessing module 215 associated with the frame included in training sequence 230 to an accumulated density per ray \tilde{α}(Θ) generated by volumetric renderer 260:

$${ℒ}_{mat} := MSE ( ℳ , \tilde{α} ( Θ ) ) \qquad Equation ( 4 )$$

The [symbol] loss of Equation (4) penalizes a rendered frame 265 that contains visual data located outside of the pixels associated with the mask [symbol] generated by preprocessing module 215. The areas within an image included in a frame of image data 205 that lie outside of the mask [symbol] should only depict a black background included in capture apparatus 200, and the corresponding regions of rendered frame 265 should depict the black background as well.

The [symbol] loss of Equation (4) is combined with additional loss terms to generate the total loss function [symbol] :

$$ℒ = {λ}_{pho} {ℒ}_{pho} + {λ}_{geo} {ℒ}_{geo} + {λ}_{vol} {ℒ}_{vol} + {λ}_{kld} {ℒ}_{kld} + {λ}_{mat} {ℒ}_{mat} \qquad Equation ( 5 )$$

$$with$$

$${λ}_{pho} = 1 \text{.0} , {λ}_{geo} = 0 \text{.1} , {λ}_{vol} = 0.01$$

$${λ}_{kld} = 0.001 , {λ}_{mat} = 0.1$$

In Equation (5), [symbol] represents a photometric reconstruction loss that enforces that rendered frame 265 matches the ground truth image included in training sequence 230. [symbol] represents a mesh reconstruction loss that enforces similarity between 3D meshes generated by tracking module 220 and interpolation module 225 and the mesh representation generated by mesh encoder network 235. [symbol] represents a constraint that the volumetric primitives should be as small as possible. Larger volumetric primitives may exhibit excessive overlap in regions included in 3D MVP Frame 255 that are already well-defined. Larger volumetric primitives may also reduce the apparent resolution of rendered frame 265 if the primitives overlap empty space that should not include visual content. [symbol] represents a Kullback-Leibler divergence prior that regularizes the latent space of mesh encoder network 235, providing improved generalizability and avoiding overfitting input data from training sequence 230. The terms λₚₕₒ, λ_{geo}, λᵥₒₗ, λ_{kid}, and λₘₐₜ representing weighting terms associated with their respective losses. The weighting term values shown are examples, and may differ in various embodiments.

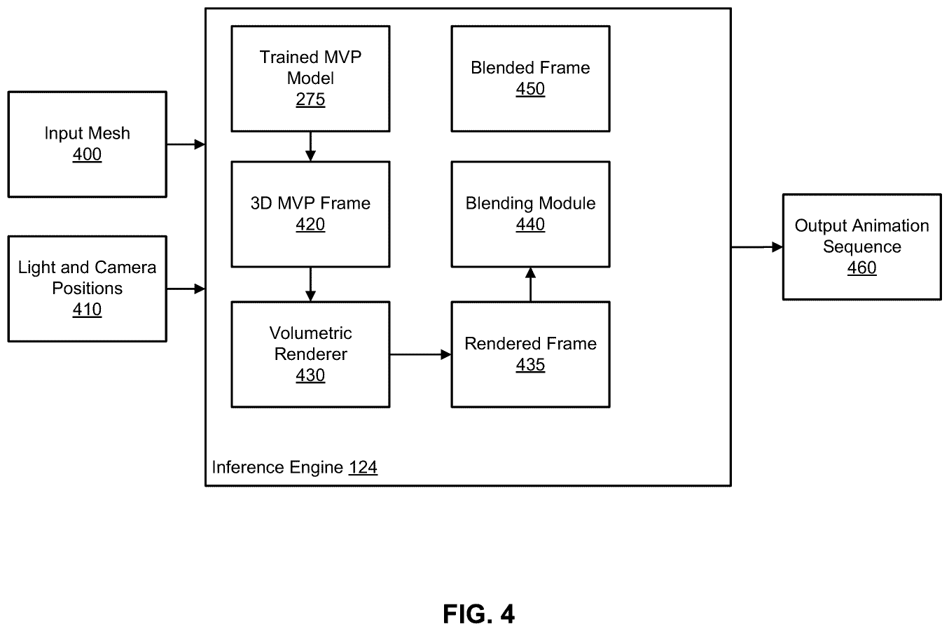

Based on values calculated for loss functions 270, training engine 122 may modify one or more adjustable internal weights included in one or more of mesh encoder network 235, geometry decoder 245, appearance decoder 250, and the single-layer MLP (not shown) that maps the 256-dimensional expression parameter 240 for input to geometry decoder 245 and appearance decoder 250. Training engine 122 may continue to iteratively modify the one or more adjustable internal weights based on additional frames included in image data 205. In various embodiments, training engine 122 may modify the one or more adjustable internal weights for a fixed number of iterations, e.g., 200,000, or until one or more of the loss functions included in Equation (5) are below one or more predetermined thresholds. Training engine 122 generates trained MVP model 275 including the components mesh encoder network 235, expression parameter 240, single-layer MLP (not shown), geometry decoder 245, appearance decoder 250, and the modified adjustable internal weights associated with each component. Training engine 122 transmits trained MVP model 275 to inference engine 124 discussed below in the description of FIG. 4.

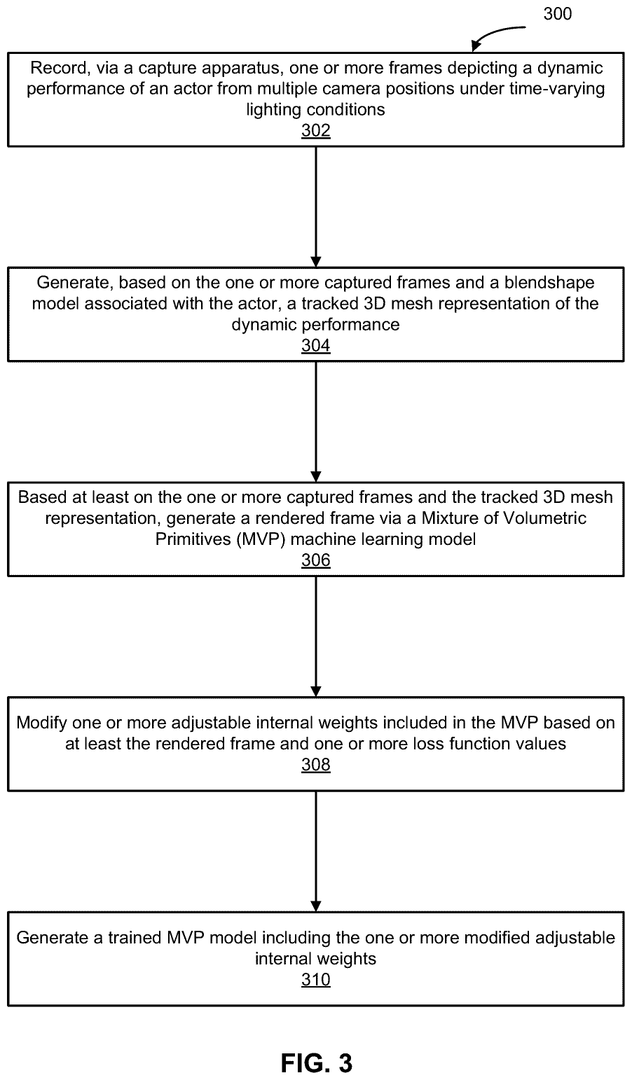

FIG. 3 is a flow diagram of method steps for training relightable Mixture of Volumetric Primitives (MVP) model 132 of FIG. 2, according to some embodiments. Although the method steps are described in conjunction with the systems of FIGS. 1 and 2, persons skilled in the art will understand that any system configured to perform the method steps in any order falls within the scope of the present disclosure.

As shown, in step 302 of method 300, capture apparatus 200 records one or more frames depicting a dynamic performance of an actor from multiple camera positions under time-varying lighting conditions. In various embodiments, capture apparatus 200 includes an arrangement of multiple cameras and multiple light sources, operable to capture multiple 2D representations of a 3D scene including one or more objects. In various embodiments, the 3D scene may include a human actor positioned such that each of the multiple light sources is operable to illuminate the actor's head and each of the multiple cameras is operable to capture an image of the actor's head. For example, the 3D scene may be illuminated by one or more of thirty-two light sources positioned in different locations within a frontal hemisphere of a capture volume, and the 3D scene may be captured by one or more of ten cameras positioned in different locations within the frontal hemisphere of the capture volume, where the positions of the multiple cameras and multiple light sources are calibrated within a 3D coordinate system. Capture apparatus 200 may illuminate the 3D scene via a one-light-at-a-time (OLAT) technique, where only one of the multiple light sources is illuminated while capturing the 3D scene. Capture apparatus 200 may also illuminate the 3D scene via a full-on technique, where all of the multiple light sources are illuminated while capturing the 3D scene.

In various embodiments, capture apparatus 200 may capture a dynamic performance of a human actor included in the 3D scene while flashing a dedicated lighting sequence consisting of one illuminated light source per frame (OLAT frames). Capture apparatus 200 may also intermix a full-on frame illuminated by all of the multiple light sources once every predetermined number of frames, e.g., every three frames. Capture apparatus 200 captures the full-on frames to improve the subsequent tracking of a 3D mesh representation of the actor's head.

In an embodiment including 32 light sources, capture apparatus 200 may therefore capture a sequence of frames include OLAT frames O₁, O₂, O₃, O₄, . . . , O₃₁, O₃₂ and full-on frames F in the predetermined lighting sequence F, O₁, O₂, F, O₃, O₄, F, . . . , F, O₃₁, O₃₂. Each of the OLAT frames O₁, O₂, O₃, O₄, . . . , O₃₁, O₃₂ represents a frame captured while the 3D scene is illuminated by a different one of the multiple, e.g., thirty-two light sources, while each of the full-on frames F represents a frame captured while the 3D scene is illuminated by all of the light sources. Capture apparatus 200 captures the dynamic performance at a predetermined frame rate, e.g., twenty-four frames per second, while repeating the above predetermined lighting sequence throughout the duration of the captured dynamic performance.

Each recorded frame includes multiple images of the actor's head captured at a particular instant via the multiple, e.g., ten, cameras. As described above, some of the frames included in the sequence of frames represent OLAT frames illuminated by an individual light source, while other frames included in the sequence of frames represent full-on frames illuminated by all of the multiple light sources.

In step 304, training engine 122 generates a tracked 3D mesh representation of the actor's performance, based on the one or more recorded frames and precomputed blendshape model 210 associated with the actor. Blendshape model 210 includes one or more parameters describing the shape of the specific actor's head captured by capture apparatus 200. In various embodiments, the disclosed techniques include precomputing blendshape model 210 based on a set of 3D face scans of the specific actor.

Tracking module 220 generates a 3D mesh based on blendshape model 210 and associated with an image included in image data 205. In various embodiments, tracking module 220 generates a 3D mesh associated with each of the images included in a frame captured by capture apparatus 200 under full-on lighting, rather than under OLAT lighting. Tracking module 220 modifies the parameters included in blendshape model 210 via any suitable 3D face tracking technique that is operable to match 2D landmarks detected within multiple, e.g., ten, images included in a frame captured under full-on lighting. In various embodiments, the parameters included in blendshape model 210 encode both a facial expression and a head pose associated with the actor. Tracking module 220 generates the tracked 3D mesh associated with an image based only on the facial expression depicted in the image. Tracking module 220 analyzes the relatively small per-frame variations in the actor's head pose and inversely offsets the per-frame camera position based on the head pose variations. Offsetting the per-frame camera position based on the head pose variations effectively places the images in a consistent, stabilized 3D space.

Interpolation module 225 generates a 3D mesh for each image included in a frame captured by capture apparatus 200 under OLAT lighting conditions. The OLAT illumination may not be sufficient for a 3D face tracking technique to detect and match 2D landmarks included in multiple images included in an OLAT frame. Interpolation module 225 instead estimates parameters included in blendshape model 210 and associated with each OLAT image via any suitable interpolation technique executed on the full-on frames adjacent to the OLAT frames. For example, given the predetermined lighting sequence F, O₁, O₂, F, O₃, O₄, F, . . . , F, O₃₁, O₃₂ discussed above, interpolation module 225 may estimate blendshape model 210 parameters for OLAT frames O₁ and O₂ via interpolation between blendshape model 210 parameters included in the full-on frames F captured before and after OLAT frames O₁ and O₂. Interpolation module 225 generates a 3D mesh associated with each OLAT image based on the interpolated blendshape model 210 parameters. Training engine 122 generates training sequence 230 including the tracked 3D mesh representation and images associated with each of the OLAT frames.

In step 306, training engine 122 generates rendered frame 265 via relightable MVP model 232 and volumetric renderer 260. Mesh encoder network 235 included in relightable MVP model 232 generates expression parameter 240 based on a 3D mesh included in training sequence 230. Expression parameter 240 encodes the facial expression associated with a corresponding OLAT image included in training sequence 230. Training engine 122 transmits expression parameter 240 to geometry decoder 245 and appearance decoder 250 included in relightable MVP model 232.

Geometry decoder 245 iteratively modifies the position, orientation, and size of each of one or more volumetric primitives, e.g., cubes, included in a set of volumetric primitives associated with the 3D mesh included in training sequence 230. After modifying the one or more volumetric primitives, geometry decoder also calculates local view directions and local lighting directions associated with each of the volumetric primitives. A local view direction defines a direction from the camera position included in training sequence 230 to the modified location of the volumetric primitive. Likewise, a local lighting direction defines a direction from the OLAT light source position included in training sequence 230 to the modified location of the volumetric primitive. Geometry decoder 245 transmits the local view and lighting directions to appearance decoder 250.

Appearance decoder 250 includes a machine learning model, e.g., a convolutional neural network, that estimates the appearance of each of the volumetric primitives based on expression parameter 240 and the local view and lighting directions received from geometry decoder 245. The appearance of each primitive is defined by a dense voxel grid of color information that stores the RGBα value per voxel.

Appearance decoder 250 receives expression parameter 240 as input and estimates the color and opacity (RGBα) values associated with each primitive included in the set of 3D primitives. Appearance decoder 250 estimates the RGBα values associated with each primitive in UV space based on expression parameter 240 and the local view and lighting directions received from geometry decoder 245.

Appearance decoder 250 combines and stores the local view and light directions per primitive as a single 6-channel image in UV space at a full network output resolution. Appearance decoder 250 copies the view and light vectors to every voxel within an individual primitive. In various embodiments, appearance decoder 250 includes seven transpose convolution layers. The inputs to the convolutional layers are the previous feature maps, starting with the 8×8 map representing reshaped expression parameter 240 and the six channels representing the local view and light directions, bilinearly downsampled to match the current spatial resolution. The output features generated by the seven transpose convolution layers include channels having dimensionalities of 256,128,128,64,64,32, and 48, respectively, where the final 48 channels are interpreted as RGB values for a voxel included in the volumetric primitive.

The local view and light conditioning allows the disclosed techniques to model nearfield lighting and viewpoints, as well as global lighting and viewpoints. The local view and light conditioning is only applied to the RGB component of the output, as opacity α is independent of illumination and view direction. Training engine 122 combines the estimated primitive geometry received from geometry decoder 245 with the estimated primitive appearances received from appearance decoder 250 to generate 3D MVP frame 255.

3D MVP frame 255 includes the set of 3D primitives each having geometry, e.g., position, orientation, and size, estimated by geometry decoder 245 and appearance estimated by appearance decoder 250. Training engine 122 transmits 3D MVP frame 255 to volumetric renderer 260 and loss functions 270.

Volumetric renderer 260 receives 3D MVP frame 255 and generates rendered frame 265 via any suitable volumetric rendering technique, such as a differentiable raytracer. Based on the camera position associated with 3D MVP frame 255 and the volumetric data included in 3D MVP frame 255, including the geometry information and appearance information associated with the set of 3D primitives, volumetric renderer 260 generates rendered frame 265 representing the actor as depicted in a corresponding frame included in training sequence 230 and processed by relightable MVP model 232. Rendered frame 265 includes an associated final resolution, e.g., 1024×1024 pixels, where each pixel includes RGBα color and opacity information. Training engine 122 transmits rendered frame 265 to loss functions 270.

In step 308, training engine 122 modifies one or more adjustable internal weights included in relightable MVP model 232 based on rendered frame 265, 3D MVP frame 255, and one or more loss functions 270. Loss functions 270 evaluate the fidelity of rendered frame 265 to a corresponding frame included in training sequence 230 and processed by relightable MVP model 232 as described above. Loss functions 270 include a matting loss that compares a mask [symbol] generated by preprocessing module 215 associated with the frame included in training sequence 230 to an accumulated density per ray \tilde{α}(Θ) generated by volumetric renderer 260:

$${ℒ}_{mat} := MSE ( ℳ , \tilde{α} ( Θ ) ) \qquad Equation ( 4 )$$

The [symbol] loss of Equation (4) penalizes a rendered frame 265 that contains visual data located outside of the pixels associated with the mask [symbol] generated by preprocessing module 215. The areas within an image included in a frame of image data 205 that lie outside of the mask [symbol] should only depict a black background included in capture apparatus 200, and the corresponding regions of rendered frame 265 should depict the black background as well.

The [symbol] loss of Equation (4) is combined with additional loss terms to generate the total loss function [symbol] :

$$ℒ = {λ}_{pho} {ℒ}_{pho} + {λ}_{geo} {ℒ}_{geo} + {λ}_{vol} {ℒ}_{vol} + {λ}_{kld} {ℒ}_{kld} + {λ}_{mat} {ℒ}_{mat} \qquad Equation ( 5 )$$

$$with$$

$${λ}_{pho} = 1 \text{.0} , {λ}_{geo} = 0 \text{.1} , {λ}_{vol} = 0.01$$

$${λ}_{kld} = 0.001 , {λ}_{mat} = 0.1$$

In Equation (5), [symbol] represents a photometric reconstruction loss that enforces that rendered frame 265 matches the ground truth image included in training sequence 230. [symbol] represents a mesh reconstruction loss that enforces similarity between 3D meshes generated by tracking module 220 and interpolation module 225 and the mesh representation generated by mesh encoder network 235. [symbol] represents a constraint that the volumetric primitives should be as small as possible. Larger volumetric primitives may exhibit excessive overlap in regions that are already well-defined. Larger volumetric primitives may also reduce the apparent resolution of rendered frame 265 if the primitives overlap empty space that should not include visual content. [symbol] represents a Kullback-Leibler divergence prior that regularizes the latent space of mesh encoder network 235, providing improved generalizability and avoiding overfitting input data from training sequence 230. The terms λₚₕₒ, λ_{geo}, λᵥₒₗ, λ_{kid}, and λₘₐₜ representing weighting terms associated with their respective losses. The weighting term values shown are examples and may differ in various embodiments.

Based on values calculated for loss functions 270, training engine 122 may modify one or more adjustable internal weights included in one or more of mesh encoder network 235, geometry decoder 245, appearance decoder 250, and the single-layer MLP (not shown) that maps the 256-dimensional expression parameter 240 for input to geometry decoder 245 and appearance decoder 250. Training engine 122 may continue to iteratively modify the one or more adjustable internal weights based on additional frames included in image data 205. In various embodiments, training engine 122 may modify the one or more adjustable internal weights for a fixed number of iterations, e.g., 200,000, or until one or more of the loss functions included in Equation (5) are below one or more predetermined thresholds.

In step 310, Training engine 122 generates trained MVP model 275 including the components mesh encoder network 235, expression parameter 240, single-layer MLP (not shown), geometry decoder 245, appearance decoder 250, and the modified adjustable internal weights associated with each component. Training engine 122 transmits trained MVP model 275 to inference engine 124.

FIG. 4 is a more detailed illustration of inference engine 124 of FIG. 1, according to some embodiments. Inference engine 124 receives input mesh 400 and virtual light and camera positions 410, and generates output animation sequence 460. Inference engine 124 includes, without limitation, trained MVP model 275, 3D MVP frame 420, volumetric renderer 430, rendered frame 435, blending module 440, and blended frame 450.

Input mesh 400 includes a 3D mesh representation of an object, such as a human actor's head. In various embodiments, input mesh 400 includes a 3D mesh representation of the same actor depicted in image data 205 used to train relightable MVP model 232 as discussed above in the description of FIG. 2. The 3D mesh representation included in input mesh 400 exhibits a facial expression used to condition trained MVP model 275 discussed below.

Light and camera positions 410 include locations in a 3D world space associated with a virtual camera position and one or more virtual light source positions. Light and camera positions 410 are used to further condition trained MVP model 275. In various embodiments, each of the virtual light source positions included in light and camera positions 410 may include a light intensity value associated with a virtual light source located at the corresponding light position. The light intensity value may be expressed as a relative or absolute measure of the brightness of the virtual light source located at the corresponding light position.

Inference engine 124 is operable to generate a synthetic rendering of a 3D scene including the actor depicted in input mesh 400, based on the virtual camera and light source positions included in light and camera positions 410. In various embodiments, inference engine 124 may generate a rendered depiction of the 3D scene as illuminated by multiple virtual light sources, rather than by a single virtual light source. For a 3D scene illuminated by multiple virtual light sources defined in light and camera positions 410, inference engine 124 may generate multiple rendered depictions of the 3D scene, where each of the multiple rendered depictions is generated by conditioning trained MVP model 275 on the light position of a single virtual light source included in the multiple virtual light sources. Inference engine 124 may then blend the multiple rendered depictions together via blending module 440 discussed below to generate blended frame 450, based on the light intensity values associated with each of the multiple virtual light sources.

Trained MVP model 275 includes relightable MVP model 232, as trained by training engine 122 discussed above in the description of FIG. 2. In various embodiments, trained MVP model receives a 3D mesh representation of an actor's face, including an associated facial expression. Trained MVP model 275 further generates local lighting and view directions based on the relative positions of a virtual camera, one or more virtual light sources, and the location of each volumetric primitive included in a set of volumetric primitives associated with input mesh 400.

The components and operation of trained MVP model 275 are the same as discussed above in the description of FIG. 2. Based on input mesh 400 and light and camera positions 410, trained MVP model 275 estimates 3D MVP frame 420. In embodiments where light and camera positions 410 includes multiple light source positions each associated with a different virtual light source included in the multiple virtual light sources, inference engine 124 may execute trained MVP model 275 during multiple iterations, transmitting a different virtual light source position included in the multiple virtual light source positions during each iteration. Trained MVP engine 275 may generate a different 3D MVP frame 420 during each iteration. Inference engine 124 may render and blend the multiple 3D MVP frames 420 to produce a single blended frame including illumination contributions from each of the multiple virtual light sources included in light and camera positions 410.

3D MVP frame 420 includes a set of 3D volumetric 3D primitives { [symbol] ₖ}, where each 3D primitive includes a position, orientation, size, and appearance estimated by trained MVP model 275. Collectively, the set of 3D primitives { [symbol] } form a volumetric representation of a 3D scene, including an actor and a facial expression associated with the actor. Inference engine 124 transmits 3D MVP frame 420 to volumetric renderer 430.

Volumetric renderer 430 generates rendered frame 435 via any suitable volumetric rendering technique, such as a differentiable raytracer. In various embodiments, volumetric renderer 430 may employ the same volumetric rendering technique as volumetric renderer 260 discussed above. Based on the camera position associated with 3D MVP frame 420 and the volumetric data included in 3D MVP frame 420, including the geometry information and appearance information associated with the set of 3D primitives { [symbol] }, volumetric renderer 430 generates rendered frame 435 representing an actor having a facial expression based on input mesh 400 and illuminated by a virtual light source included in light and camera positions 410. Inference engine 124 transmits rendered frame 435 to blending module 440.

Blending module 440 stores and combines multiple rendered frames 435 received from volumetric renderer 430, where each of the multiple rendered frames 435 depicts the same actor and same facial expression illuminated by a different virtual light source included in light and camera positions 410. In various embodiments, blending module 440 combines multiple rendered frames 435 via a weighted combination, where a blending weight associated with each of multiple rendered frames 435 is based on an absolute or relative light intensity value associated with a virtual light source corresponding to the rendered frame 435. For example, given an input mesh 400, and light and camera positions 410 including positions and intensities associated with four different virtual light source having relative intensities of 30%, 20%, 25%, and 25% respectively, inference engine 124 may generate four different rendered frames 435 and transmit the four different rendered frames 435 to blending module 440. Blending module 440 assigns blending weights to each of the four rendered frames 435 based on the associated relative intensities, e.g., 0.3, 0.2, 0.25, and 0.25, respectively, and generates blended frame 450 based on a weighted combination of the four rendered frames 435 according to the respective blending weights. In a different example where light and camera positions 410 only includes a single virtual light source, blending module 440 may assign a blending weight of, e.g., 1.0 to the single light source indicating that blended frame 450 depicts an illumination environment including a single virtual light source. In this case, no blending may be necessary, and blended frame 450 may therefore be identical to rendered frame 435.

Blended frame 450 includes a 2D raster image including the weighted combination of the one or more rendered frames 435 generated by volumetric renderer 430. Blended frame 450 depicts an actor and facial expression represented by input mesh 400, viewed from a virtual camera position included in light and camera positions 410 and illuminated by one or more virtual light sources included in light and camera positions 410.

Inference engine 124 may process additional instances of input mesh 400 and/or light and camera positions 410 and generate multiple corresponding instances of blended frame 450. Inference engine 124 may further combine the multiple instances of blended frame 450 into output animation sequence 460.

Output animation sequence 460 depicts an animated performance of an actor, including time-varying facial expressions exhibited by the actor, where the time-varying facial expressions are based on multiple sequential instances of input mesh 400. Output animation sequence 460 may also depict the animated performance of the actor from a time-varying virtual camera position, where the time-varying camera position is based on virtual camera locations included in multiple sequential instances of light and camera positions 410. Output animation sequence 460 may further depict the animated performance of the actor under time-varying lighting conditions, where the time-varying lighting conditions are based on virtual light source positions and intensities included in multiple sequential instances of light and camera positions 410.

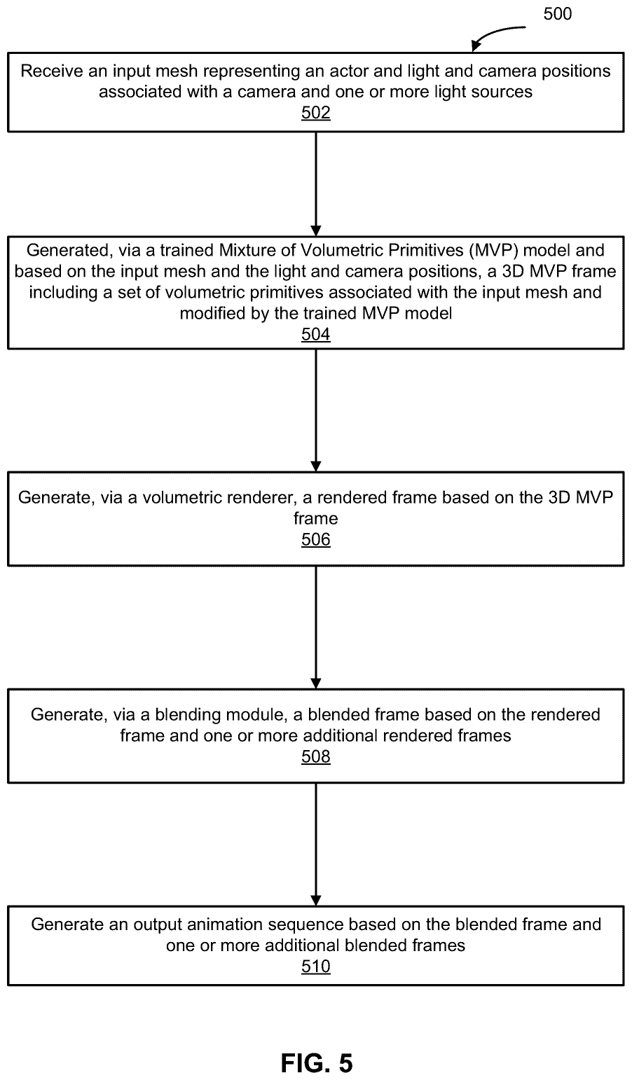

FIG. 5 is a flow diagram of method steps for generating an output animation sequence via inference engine 124, according to some embodiments. Although the method steps are described in conjunction with the systems of FIGS. 1-2 and 4, persons skilled in the art will understand that any system configured to perform the method steps in any order falls within the scope of the present disclosure.

As shown, in step 502 of method 500, inference engine 124 receives an input mesh 400 and light and camera positions 410. Input mesh 400 includes a 3D mesh representation of an object, such as a human actor's head. In various embodiments, input mesh 400 includes a 3D mesh representation of the same actor depicted in image data 205 used to train relightable MVP model 232 as discussed above in the description of FIG. 2. The 3D mesh representation included in input mesh 400 exhibits a facial expression used to condition trained MVP model 275.

Light and camera positions 410 include locations in a 3D world space associated with a virtual camera position and one or more light source positions. Light and camera positions 410 are used to further condition trained MVP model 275. In various embodiments, each of the light positions included in light and camera positions 410 may include a light intensity value associated with a light located at the corresponding light position. The light intensity value may be expressed as a relative or absolute measure of the brightness of the light located at the corresponding light position.

In step 504, inference engine 124 generates 3D MVP frame 420 via trained MVP model 275. Trained MVP model 275 includes relightable MVP model 232, as trained by training engine 122 discussed above in the description of FIG. 2. Trained MVP model 275 further generates local lighting and view directions based on the relative positions of a virtual camera, one or more light sources, and the location of each volumetric primitive included in a set of volumetric primitives associated with input mesh 400.

The components and operation of trained MVP model 275 are the same as discussed above in the description of FIG. 2. Based on input mesh 400 and light and camera positions 410, trained MVP model 275 estimates 3D MVP frame 420. In embodiments where light and camera positions 410 includes multiple light source positions each associated with a different virtual light source included in the multiple virtual light sources, inference engine 124 may execute trained MVP model 275 during multiple iterations, transmitting a different light source position included in the multiple light source positions during each iteration. Trained MVP engine 275 may generate a different 3D MVP frame 420 during each iteration. Inference engine 124 may render and blend the multiple 3D MVP frames 420 to produce a single blended frame including illumination contributions from each of the multiple virtual light sources included in light and camera positions 410.

3D MVP frame 420 includes a set of 3D volumetric 3D primitives { [symbol] }, where each 3D primitive includes a position, orientation, size, and appearance estimated by trained MVP model 275. Collectively, the set of 3D primitives { [symbol] } form a volumetric representation of a 3D scene, including an actor and a facial expression associated with the actor. Inference engine 124 transmits 3D MVP frame 420 to volumetric renderer 430.

In step 506, volumetric renderer 430 generates rendered frame 435 via any suitable volumetric rendering technique, such as a differentiable raytracer. In various embodiments, volumetric renderer 430 may employ the same volumetric rendering technique as volumetric renderer 260 discussed above. Based on the virtual camera position associated with 3D MVP frame 420 and the volumetric data included in 3D MVP frame 420, including the geometry information and appearance information associated with the set of 3D primitives { [symbol] }, volumetric renderer 430 generates rendered frame 435 representing an actor exhibiting a facial expression based on input mesh 400 and illuminated by a light source included in light and camera positions 410. Inference engine 124 transmits rendered frame 435 to blending module 440.

In step 508, blending module 440 stores and combines multiple rendered frames 435 received from volumetric renderer 430, where each of the multiple rendered frames 435 depicts the same actor and same facial expression illuminated by a different light source included in light and camera positions 410. In various embodiments, blending module 440 combines multiple rendered frames 435 via a weighted combination, where a blending weight associated with each of multiple rendered frames 435 is based on an absolute or relative light intensity value associated with a light source corresponding to the rendered frame 435. For example, given an input mesh 400, and light and camera positions 410 including positions and intensities associated with four different light source having relative intensities of 30%, 20%, 25%, and 25% respectively, inference engine 124 may generate four different rendered frames 435 and transmit the four different rendered frames 435 to blending module 440. Blending module 440 assigns blending weights to each of the four rendered frames 435 based on the associated relative intensities, e.g., 0.3, 0.2, 0.25, and 0.25, respectively, and generates blended frame 450 based on a weighted combination of the four rendered frames 435 according to the respective blending weights. In a different example where light and camera positions 410 only includes a single light source, blending module 440 may assign a blending weight of, e.g., 1.0 to the single light source indicating that blended frame 450 depicts an illumination environment including a single light source.

Blended frame 450 includes a 2D raster image including the weighted combination of the one or more rendered frames 435 generated by volumetric renderer 430. Blended frame 450 depicts an actor and facial expression represented by input mesh 400, viewed from a virtual camera position included in light and camera positions 410 and illuminated by one or more virtual light sources included in light and camera positions 410.

In step 510, inference engine 124 may process additional instances of input mesh 400 and/or light and camera positions 410 and generate multiple corresponding instances of blended frame 450. Inference engine 124 may further combine the multiple instances of blended frame 450 into output animation sequence 460.

Output animation sequence 460 depicts an animated performance of an actor, including time-varying facial expressions exhibited by the actor, where the time-varying facial expressions are based on multiple sequential instances of input mesh 400. Output animation sequence 460 may also depict the animated performance of the actor from a time-varying camera position, where the time-varying camera position is based on virtual camera locations included in multiple sequential instances of light and camera positions 410. Output animation sequence 460 may further depict the animated performance of the actor under time-varying lighting conditions, where the time-varying lighting conditions are based on light source positions and intensities included in multiple sequential instances of light and camera positions 410.

In sum, the disclosed techniques train a machine learning model, such as a relightable Mixture of Volumetric Primitives (MVP) model to generate a rendered 2D depiction of a 3D scene including one or more objects, such as an actor. The disclosed techniques train the machine learning model based on a 3D mesh associated with the one or more objects, a camera position associated with a real or virtual camera used to capture the 3D scene, and the positions of one or more light sources used to illuminate the 3D scene. The disclosed techniques may further execute the trained machine learning model to generate an animated sequence representing the 3D scene and the one or more objects as viewed from novel, time-varying virtual camera positions and under novel, time-varying virtual lighting conditions.

In operation, a capture apparatus records multiple 2D images depicting a 3D scene including one or more objects, such as an actor's head and an associated facial expression. The capture apparatus includes multiple, e.g., ten, cameras and multiple, e.g., thirty-two light sources, where each camera and light source is positioned at different calibrated locations within a 3D coordinate space. The capture apparatus sequentially records multiple one-light-at-a-time (OLAT) frames depicting the 3D scene under a predetermined sequence of lighting conditions, where each of the multiple frames includes 2D images captured by each of the multiple cameras under the illumination of a single light source included in the multiple light sources. The capture apparatus also intermixes, at a predetermined frame interval, full-on frames in which the multiple cameras capture the 3D scene under the simultaneous illumination of all of the multiple light sources. A training engine generates a tracked 3D mesh based on the full-on frames and a precomputed blendshape model associated with the actor. The training engine trains a relightable Mixture of Volumetric Primitives (MVP) model based on the recorded OLAT frames and the tracked 3D mesh.

The relightable MVP model receives the tracked 3D mesh associated with an OLAT frame, along with camera and lighting positions associated with the OLAT frame. A mesh encoder network included in the MVP model generates an expression parameter based on the 3D mesh, where the expression parameter is a vector encoding of the actor's head pose and facial expression. The MVP model transmits the expression parameter to a geometry encoder and an appearance encoder included in the MVP model.

The geometry encoder iteratively modifies the location, orientation, and size of each of a set of volumetric primitives, e.g., cubes associated with the 3D mesh. The geometry encoder also calculates local lighting and local view directions associated with each volumetric primitive included in the set of volumetric primitives. The local lighting direction associated with a volumetric primitive represents a direction from a light source position associated with the OLAT frame to the volumetric primitive. The local view direction associated with a volumetric primitive represents a direction from a camera position associated with the OLAT frame to the volumetric primitive. The geometry decoder provides the local lighting and view directions to the appearance decoder.

The appearance decoder iteratively modifies color and opacity values associated with each of the volumetric primitives, based on the local lighting and view directions received from the geometry decoder. Specifically, each volumetric primitive may include a 3D arrangement of volume elements (voxels), and the appearance decoder may modify the color and opacity values associated with each voxel included in the arrangement of voxels. The output of the MVP model includes a 3D MVP frame, where the 3D MVP frame includes the set of volumetric primitives having positions, orientations, and sizes as estimated by the geometry model and color and opacity information as estimated by the appearance engine. The training engine applies a volumetric rendering technique to the 3D MVP frame to generate a rendered 2D depiction of the 3D scene including the actor and the actor's facial expression as captured from the camera position and under the lighting conditions included in the image data. The training engine iteratively modifies one or more adjustable internal weights included in the MVP model based on one or more loss values. The one or more loss values are based on differences between the rendered 2D depiction and ground truth image data, as well as a size distribution associated with the set of volumetric primitives. The training engine may continue to iteratively modify the one or more adjustable internal weights for a predetermined number of iterations or until one or more of the loss values are below one or more determined thresholds.

At inference time, the trained MVP model receives a 3D mesh representation of an actor's head exhibiting an associated facial expression. The 3D mesh representation may include a single frame taken from a time-varying sequence of 3D mesh representations, i.e., an animated 3D mesh sequence depicting a generated dynamic actor performance. The trained MVP model also receives virtual light source positions and a virtual camera position associated with the received 3D mesh representation. The virtual light source positions define an arbitrary lighting environment, while the virtual camera position defines an arbitrary viewing location.

The trained MVP model generates a rendered frame, where the rendered frame depicts the actor exhibiting the facial expression included in the 3D mesh representation, as viewed from the defined virtual viewing location under the defined virtual lighting environment. In an example where the defined virtual lighting environment includes multiple virtual light sources, the trained MVP model may generate a different rendered frame associated with each of the multiple virtual light sources. The inference engine may then generate a blended frame including a weighted combination of the different rendered frames based on relative or absolute intensity values associated with the multiple virtual light sources.

The inference engine may continue to process additional 3D meshes and associated virtual light and camera positions. The inference engine may then combine the generated blended frames to generate an animated output sequence representing the dynamic performance of the actor as specified by the sequence of 3D meshes and associated virtual lighting and camera positions.

One technical advantage of the disclosed techniques relative to the prior art is that the disclosed techniques may generate animatable representations of a 3D scene not only from arbitrary viewpoints but also under arbitrary lighting conditions. Unlike existing techniques that are limited to producing animatable representations with fixed illumination characteristics, the disclosed techniques allow for realistically rendering animated representations of a scene into a variety of environments with different camera positions and illumination conditions, including both nearfield lighting and nearfield camera positions. These technical advantages provide one or more technological improvements over prior art approaches.
1. In some embodiments, a computer-implemented method for generating an animation sequence comprises receiving one or more three-dimensional (3D) input meshes, wherein each input mesh includes a representation of an object included in a 3D scene, receiving, for each of the one or more 3D input meshes, a virtual camera position associated with the 3D input mesh and one or more virtual lighting positions associated with the 3D input mesh, generating, for each of the one or more 3D input meshes and via a trained machine learning model, one or more rendered frames associated with the 3D input mesh, wherein each of the one or more rendered frames includes a two-dimensional (2D) representation of the object as viewed from the virtual camera position and illuminated by one or more virtual lights located at the one or more virtual lighting positions, and generating an output animation sequence based on the one or more rendered frames.
2. The computer-implemented method of clause 1, wherein the trained machine learning model includes a trained relightable Mixture of Volumetric Primitives (MVP) model.
3. The computer-implemented method of clauses 1 or 2, further comprising generating, via the trained relightable MVP model, a 3D MVP frame including a plurality of volumetric primitives, wherein each of the plurality of volumetric primitives includes position, orientation, size, color and opacity information associated with the volumetric primitive.
4. The computer-implemented method of any of clauses 1-3, wherein the object includes a human actor exhibiting a facial expression.
5. The computer-implemented method of any of clauses 1-4, wherein the 3D input mesh is based on a blendshape model associated with the human actor.
6. The computer-implemented method of any of clauses 1-5, further comprising blending two or more of the rendered frames, wherein each of the two or more rendered frames is associated with a single virtual lighting position.
7. The computer-implemented method of any of clauses 1-6, wherein blending the two or more rendered frames is based at least on light intensity values associated with the one or more virtual lights.
8. The computer-implemented method of any of clauses 1-7, wherein the rendered frame includes a 2D raster image including a plurality of pixels each including color and opacity values.
9. The computer-implemented method of any of clauses 1-8, wherein the trained machine learning model calculates one or more local view directions associated with the virtual camera position.
10. The computer-implemented method of any of clauses 1-9, wherein the trained machine learning model calculates one or more local lighting directions associated with one of the one or more virtual lighting positions.
11. In some embodiments, one or more non-transitory computer-readable media store instructions that, when executed by one or more processors, cause the one or more processors to perform the steps of receiving one or more three-dimensional (3D) input meshes, wherein each input mesh includes a representation of an object included in a 3D scene, receiving, for each of the one or more 3D input meshes, a virtual camera position associated with the 3D input mesh and one or more virtual lighting positions associated with the 3D input mesh, generating, for each of the multiple 3D input meshes and via a trained machine learning model, one or more rendered frames associated with the 3D input mesh, wherein each of the one or more rendered frames includes a two-dimensional (2D) representation of the object as viewed from the virtual camera position and illuminated by one or more virtual lights located at the one or more virtual lighting positions, and generating an output animation sequence based on the one or more rendered frames.
12. The one or more non-transitory computer-readable media of clause 11, wherein the trained machine learning model includes a trained relightable Mixture of Volumetric Primitives (MVP) model.
13. The one or more non-transitory computer-readable media of clauses 11 or 12, further comprising generating, via the trained relightable MVP model, a 3D MVP frame including a plurality of volumetric primitives, wherein each of the plurality of volumetric primitives includes position, orientation, size, color and opacity information associated with the volumetric primitive.
14. The one or more non-transitory computer-readable media of any of clauses 11-13, wherein the object includes a human actor exhibiting a facial expression.
15. The one or more non-transitory computer-readable media of any of clauses 11-14, further comprising blending two or more of the rendered frames, wherein each of the two or more rendered frames is associated with a single virtual lighting position.
16. The one or more non-transitory computer-readable media of any of clauses 11-15, wherein blending the two or more rendered frames is based at least on light intensity values associated with the one or more virtual lights.
17. The one or more non-transitory computer-readable media of any of clauses 11-16, wherein the trained machine learning model calculates one or more local view directions associated with the virtual camera position.
18. The one or more non-transitory computer-readable media of any of clauses 11-17, wherein the trained machine learning model calculates one or more local lighting directions associated with one of the one or more virtual lighting positions.
19. In some embodiments, a system comprises one or more memories storing instructions, and one or more processors for executing the instructions to receive one or more three-dimensional (3D) input meshes, wherein each input mesh includes a representation of an object included in a 3D scene, receive, for each of the one or more 3D input meshes, a virtual camera position associated with the 3D input mesh and one or more virtual lighting positions associated with the 3D input mesh, generate, for each of the one or more 3D input meshes and via a trained machine learning model, one or more rendered frames associated with the 3D input mesh, wherein each of the one or more rendered frames includes a two-dimensional (2D) representation of the object as viewed from the virtual camera position and illuminated by one or more virtual lights located at the one or more virtual lighting positions, and generate an output animation sequence based on the multiple rendered frames.
20. The system of clause 19, wherein the trained machine learning model includes a trained relightable Mixture of Volumetric Primitives (MVP) model, the one or more processors further executing the instructions to generate, via the trained relightable MVP model, a 3D MVP frame including a plurality of volumetric primitives, wherein each of the plurality of volumetric primitives includes position, orientation, size, color and opacity information associated with the volumetric primitive. Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating an animation sequence, the method comprising:
receiving one or more three-dimensional (3D) input meshes, wherein each input mesh includes a representation of an object included in a 3D scene;
receiving, for each of the one or more 3D input meshes, a virtual camera position associated with the 3D input mesh and one or more virtual lighting positions associated with the 3D input mesh;
generating, for each of the one or more 3D input meshes and via a trained machine learning model, one or more rendered frames associated with the 3D input mesh, wherein each of the one or more rendered frames includes a two-dimensional (2D) representation of the object as viewed from the virtual camera position and illuminated by one or more virtual lights located at the one or more virtual lighting positions; and
generating an output animation sequence based on the one or more rendered frames.

2. The computer-implemented method of claim 1, wherein the trained machine learning model includes a trained relightable Mixture of Volumetric Primitives (MVP) model.

3. The computer-implemented method of claim 2, further comprising generating, via the trained relightable MVP model, a 3D MVP frame including a plurality of volumetric primitives, wherein each of the plurality of volumetric primitives includes position, orientation, size, color and opacity information associated with the volumetric primitive.

4. The computer-implemented method of claim 1, wherein the object includes a human actor exhibiting a facial expression.

5. The computer-implemented method of claim 4, wherein the 3D input mesh is based on a blendshape model associated with the human actor.

6. The computer-implemented method of claim 1, further comprising blending two or more of the rendered frames, wherein each of the two or more rendered frames is associated with a single virtual lighting position.

7. The computer-implemented method of claim 6, wherein blending the two or more rendered frames is based at least on light intensity values associated with the one or more virtual lights.

8. The computer-implemented method of claim 1, wherein the rendered frame includes a 2D raster image including a plurality of pixels each including color and opacity values.

9. The computer-implemented method of claim 1, wherein the trained machine learning model calculates one or more local view directions associated with the virtual camera position.

10. The computer-implemented method of claim 1, wherein the trained machine learning model calculates one or more local lighting directions associated with one of the one or more virtual lighting positions.

11. One or more non-transitory computer-readable media storing instructions that, when executed by one or more processors, cause the one or more processors to perform the steps of:
receiving one or more three-dimensional (3D) input meshes, wherein each input mesh includes a representation of an object included in a 3D scene;
receiving, for each of the one or more 3D input meshes, a virtual camera position associated with the 3D input mesh and one or more virtual lighting positions associated with the 3D input mesh;
generating, for each of the multiple 3D input meshes and via a trained machine learning model, one or more rendered frames associated with the 3D input mesh, wherein each of the one or more rendered frames includes a two-dimensional (2D) representation of the object as viewed from the virtual camera position and illuminated by one or more virtual lights located at the one or more virtual lighting positions; and
generating an output animation sequence based on the one or more rendered frames.

12. The one or more non-transitory computer-readable media of claim 11, wherein the trained machine learning model includes a trained relightable Mixture of Volumetric Primitives (MVP) model.

13. The one or more non-transitory computer-readable media of claim 12, further comprising generating, via the trained relightable MVP model, a 3D MVP frame including a plurality of volumetric primitives, wherein each of the plurality of volumetric primitives includes position, orientation, size, color and opacity information associated with the volumetric primitive.

14. The one or more non-transitory computer-readable media of claim 11, wherein the object includes a human actor exhibiting a facial expression.

15. The one or more non-transitory computer-readable media of claim 11, further comprising blending two or more of the rendered frames, wherein each of the two or more rendered frames is associated with a single virtual lighting position.

16. The one or more non-transitory computer-readable media of claim 15, wherein blending the two or more rendered frames is based at least on light intensity values associated with the one or more virtual lights.

17. The one or more non-transitory computer-readable media of claim 11, wherein the trained machine learning model calculates one or more local view directions associated with the virtual camera position.

18. The one or more non-transitory computer-readable media of claim 11, wherein the trained machine learning model calculates one or more local lighting directions associated with one of the one or more virtual lighting positions.

19. A system comprising:
one or more memories storing instructions; and
one or more processors for executing the instructions to:
receive one or more three-dimensional (3D) input meshes, wherein each input mesh includes a representation of an object included in a 3D scene;
receive, for each of the one or more 3D input meshes, a virtual camera position associated with the 3D input mesh and one or more virtual lighting positions associated with the 3D input mesh;
generate, for each of the one or more 3D input meshes and via a trained machine learning model, one or more rendered frames associated with the 3D input mesh, wherein each of the one or more rendered frames includes a two-dimensional (2D) representation of the object as viewed from the virtual camera position and illuminated by one or more virtual lights located at the one or more virtual lighting positions; and
generate an output animation sequence based on the multiple rendered frames.

20. The system of claim 19, wherein the trained machine learning model includes a trained relightable Mixture of Volumetric Primitives (MVP) model, the one or more processors further executing the instructions to generate, via the trained relightable MVP model, a 3D MVP frame including a plurality of volumetric primitives, wherein each of the plurality of volumetric primitives includes position, orientation, size, color and opacity information associated with the volumetric primitive.
